(19) United States
(12) Patent Application Publication
(10) Pub. No.: US 2002/0075509 A1
(43) Pub. Date: Jun. 20, 2002

(54) System and method for printing a document for a network user

(76) Inventor: Alejandro Wiechers, Chapalita Guadalajara (MX)

Correspondence Address: HEWLETT-PACKARD COMPANY, Intellectual Property Administration, P.O. Box 272400, Fort Collins, CO, 80527-2400, US

(21) Appl. No.: 09/745,711

(22) Filed: Dec. 18, 2000

(51) Int. Cl. G06F 15/00; G06K 1/00

(52) U.S. Cl. 358/1.15; 358/1.14

(57) ABSTRACT

A printer selection system includes a communications network linked with a network addressable device. The network addressable device includes a global printer array and an assessor. Through the communications network, the assessor receives from a network user a print command along with network user parameters. With the network user parameters, the assessor selects a localized printer from the global printer array to meet user parameters and to optimize time and printing costs. The assessor selects the localized printer via computer program code accompanying the network addressable device. The program code, in particular, executes a print sequence as well as a printer search routine. Accordingly, the print command is forwarded to the localized printer. The localized printer executes a resulting print job at a minimum distance from the network user and within the network user parameters.

### FIELD OF THE INVENTION

This invention relates to a printer selection system and method. In particular, the invention relates to a system and method for printing a document for a network user. The system and method are intended to select a network printer based on given network user parameters so that the printer is at a minimum distance from the network user.

### BACKGROUND OF THE INVENTION

Typically, if one wishes to print a document from an electronic device such as a computer or a handheld wireless device for example, a printer sends a single print command. It becomes difficult for a printer to carry out a print command if more than one computer, for example, is linked or “networked” with the same printer. A printer must still execute one print command at a time despite a potentially high demand from networked computers.

To mitigate the number of print commands received by a printer at any given time, additional printers are commonly networked so that each computer is linked with each printer. Unfortunately, increasing the number of computers and printers within a network creates additional problems.

One critical problem becomes selecting a printer that is closest to the network user. For example, if all the printers are busy at one office building a network user may need to retrieve a print job by walking to a printer in another building. Accordingly, with increasing distance from a printer, a network user needlessly expends more time and associated business costs in retrieving a print job. This distance problem is intensified when a print command is sent over a global printer array within a large communications network, such as an Internet or large intranet environment where the nearest available printer may be in another city. It should be said that in this disclosure and appended claims, the term “global printer array” is defined as all printers within a network, whereas “localized printer” refers to a single printer selected from the global printer array.

As communications networks expand and the number of network user subscribers continue to increase, the need becomes very clear for controlling the traffic flow of print commands encountered by each networked printer. Therefore, as a matter of maximizing business time and efficiently minimizing cost, there is a need for an Internet based system for controlling printer command traffic so that a network user can retrieve a print job with a minimum distance. Because not all printers provide the same services, user parameters, such as suitable paper size and type, color management, finisher capabilities, print resolution as well as printer or “spooling” speed for example, should dictate a suitable localized printer from a global printer array.

### SHORT STATEMENT OF THE INVENTION

Accordingly, the present invention is directed to a system and method for selecting a network printer based on given network user parameters so that the selected printer is at a minimum distance from the network user. In one embodiment of the invention, a printer selection system includes a communications network linked with a network addressable device. The network addressable device includes a global printer array and an assessor. The global printer array is linked with the communications network. The assessor is linked with the communications network and the global printer array. The assessor receives a print command that includes network user parameters from the network user through the communications network. With the network user parameters, the assessor selects a localized printer from the global printer array such that the selected localized printer saves time and costs associated with printing. The print command is forwarded to the localized printer. The localized printer executes a resulting print job at a location that is a minimum distance from the network user and within the network user parameters.

A computer program code accompanies the network addressable device for printing a document for a network user. The computer program code includes code for receiving network user parameters via the network addressable device as well as code for linking the network addressable device with a global printer array. The computer program code includes code for selecting a localized printer from the global printer array based on distance from the user as well as the given network user parameters.

In another embodiment of the present invention, a method for printing a document for a network user includes receiving network user parameters via a network addressable device. Based on the network user parameters, a localized printer is selected at a minimum distance from the network user. Further, the localized printer is selected from a global printer array through the network addressable device. Prior to engaging the localized printer, the network addressable device advises the network user whether the optimum localized printer is available.

In selecting the localized printer, the network addressable device establishes a pool or “localized zone” of printer candidates. A printer candidate having the least distance from the network user is designated from the localized zone. In terms of network user parameters, the network addressable device then determines whether the printer candidate sufficiently satisfies user parameters including cost and time expectations. When a suitable candidate, hence “localized printer”, is designated, the network addressable device displays the status of the localized printer to the network user for final approval. Once approved, the network addressable device sends the print command to the localized printer for spooling and execution.

### BRIEF DESCRIPTION OF THE DRAWINGS

FIG. 1 is a schematic diagram of a preferred embodiment of a printer selection system of the present invention.

FIG. 2 is a schematic diagram of a print sequence executed by an assessor from the printer selection system of FIG. 1.

FIG. 3 is a schematic diagram of a printer search routine implemented by the print sequence of FIG. 2.

### DETAILED DESCRIPTION OF THE PREFERRED EMBODIMENT

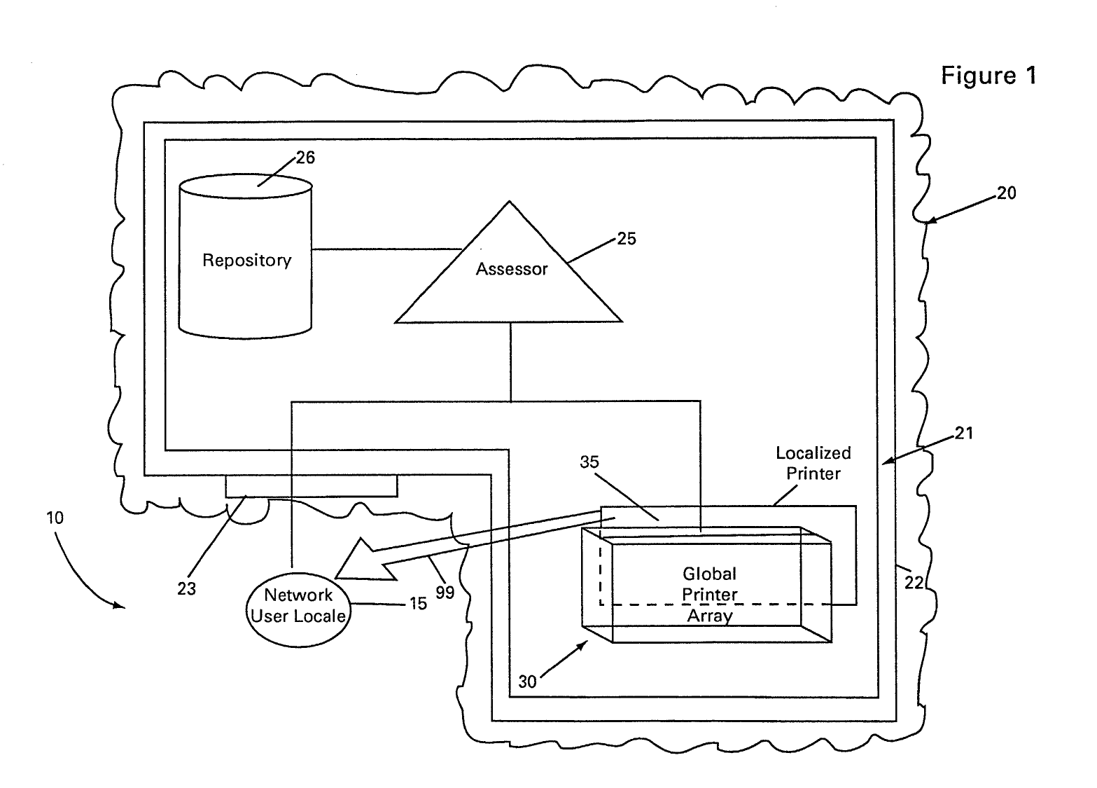

The preferred embodiment of the present invention is illustrated by way of example in FIGS. 1-3. With specific reference to FIG. 1, a printer selection system 10 includes a communications network 20 linked with a network addressable device 21.

The printer selection system 10 is constructed of various software components for processes operating on a computer or a network of computers. In the preferred embodiment, the software components or processes composing the printer selection system 10 are configured for engagement with communication networks of a type well known in the industry, such as the Internet for example. Accordingly, in a preferred embodiment the communications network 20 comprises an Internet communications network environment but other embodiments contemplate an intranet communications environment, for example.

The network addressable device 21 is a location within the communications network 20, such as an Internet address or Universal Resource Locator (URL) for example. Ultimately, the network addressable device 21 is a tool for selecting a suitable network printer. The network addressable device 21 is linked with an address server 22. The address server 22 provides user-access to the network addressable device 21. Shown in FIG. 1, the address server 22 is preferably connected with a browser 23 for facilitating access to the network addressable device 21 through a graphical format. The browser 12 is of a type well known in the art, such as NETSCAPE NAVIGATOR or MICROSOFT EXPLORER for example. Other embodiments of the printer selection system 10, however, do not incorporate a browser.

In operation, a print command is introduced to the network addressable device 21 through the browser 23 and the address server 22. A print command is executed by a network user via an electronic device, such a computer or a hand-held device such as a wireless telephone or PALM PILOT. The printer selection system 10 uses the print command to select a network printer in accordance with user predetermined criteria, such as a requirement for selecting a network printer at a minimum distance from the network user. Notably, FIG. 1 shows a network user locale 15 indicating the physical location of the network user.

Each print command includes network user selected criteria/parameters for a desired print job. The network user parameters are preferably in a digital format compatible with that of the communications network 20. In this description and the appended claims the term “network user parameters” is defined as characteristic elements required of a printer by a network user for a desired print job; such as, for example, suitable paper size and type, color management, finisher capabilities, print resolution as well as printer location and “spooling” speed.

The network addressable device 21 includes an assessor 25 and a global printer array 30. The assessor 25 is linked with the global printer array 30 and the network user. The assessor 25 receives network user parameters from the network user through the communications network 20. Preferably, the assessor 25 executes the program code exclusively for the network addressable device 21. However, those of ordinary skill in the art will recognize that the assessor 25 in other embodiments may execute other operations besides the computer program code for the network addressable device 21, such as, for example, executing program code for other network addresses.

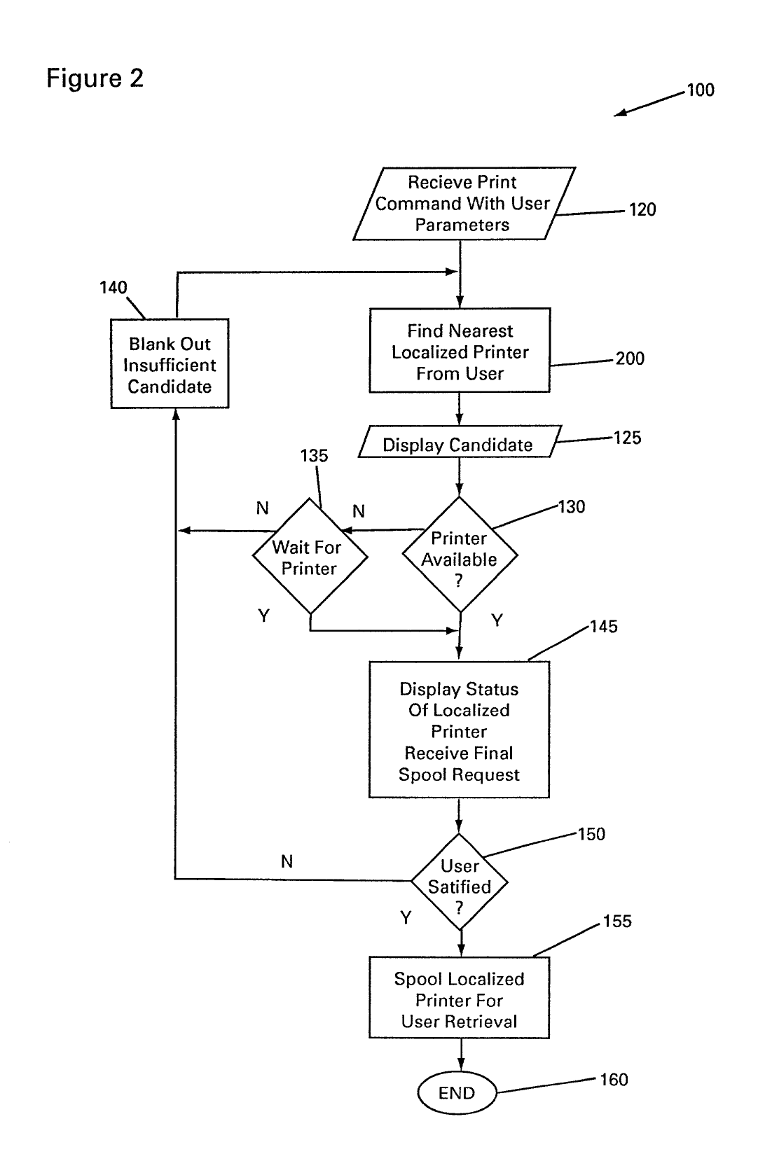

Through computer program code as shown in FIG. 2, the assessor 25 implements a print sequence 100 for selecting a localized printer from the global printer array 30. The global printer array 30 is linked with the assessor 25 as well as with the communications network 20. The global printer array 30 is defined by all printers within the communications network 20. Each printer in the global printer array 30 is configured for selective engagement by the assessor 25 in accordance with the print command sent by a network user. Because they are linked with the communications network 20, each printer is preferably positioned at a different location from that of another printer and from the network user locale 15. Obviously, multiple printers at one location is within the scope of the invention as well, wherein each printer is separately identified at a single location.

In the preferred embodiment, the global printer array 30 includes various types of printers so that the global printer array 30, as a whole, may accommodate a wide variety of network user parameters. For example, the global printer array 30 may include printers featuring variations in paper size and type, color management, finishing capabilities, print resolution as well as spooling speed. Accordingly, based on given network user parameters, the assessor 25 executes the print sequence 100 for selecting a localized printer 35 that best fits the user's criteria. The localized printer 35 is a printer selected from the global printer array 30, for example, that is located at a minimum distance from the network user locale 15 and which satisfies the other given network user parameters.

Illustratively, in one embodiment, the global printer array 30 constitutes a network of commercial printer outlets positioned about a network user's city, i.e., “cornerstore” printer outlets. These commercial cornerstore printer outlets may feature standard book on demand machines for printing material, such as for example that of U.S. Pat. No. 6,012,890 entitled “electronic bookstore vending machine” assigned to InstaBook Corporation of Gainesville, Florida. For example, a network user wishing to print construction blue prints for architectural designs first accesses the network addressable device 21. The network addressable device 21, via the print sequence 100, selects a localized printer 35 from the array of commercial printer outlets. The network addressable device 21 ensures a localized printer at a minimum distance from the user locale 15, for example, with associated cost and time savings for the network user. Optionally, as indicated in FIG. 1 as reference arrow 99, printed material, i.e. the blue prints, are delivered to the network user locale 15 by a network courier associated with the commercial printer outlets, similar to that of the fast food delivery services industry, for example.

Moreover, the global printer array 30 may include a repository 26 linked with the assessor 25. The repository 28 includes storage memory for storing information received by the repository 28 in an electronic format. The storage memory of the repository 28 is preferably apportioned into an array of memory accounts. In operation, each memory account is reserved for exclusive use by a network user subscription offered by the network addressable device 21. Therefore, the repository 26 is provided by the network addressable device so that, when accessing a memory account, a network user may store documents within the repository 26 for ready retrieval and printing by the localized printer 35. Preferably, the repository 26 also stores information associated with the localized zone of printer candidates, such as capabilities and geographical locations for each printer within the global printer array 30.

In another preferred embodiment, a computer program code executed by the assessor 25 for printing a network user document includes a first computer program code for receiving network user parameters via the network addressable device. A second computer program code is provided for linking the network addressable device 21 with the global printer array 30 whereas a third computer program code selects a localized printer from the global printer array in accordance with preselected user criteria. The computer program code further includes a fourth computer program code for determining the availability of the localized printer with respect to the preselected network user parameters. A fifth computer program code is provided for spooling the localized printer.

In operation, as shown in FIG. 2, the network addressable device 21 executes the print sequence 100. In step 120, the network addressable device 21 receives, through a browser 22, a print command from a network user. Network user parameters are included with the print command. Given the network parameters, the print sequence 100 implements a printer search routine 200.

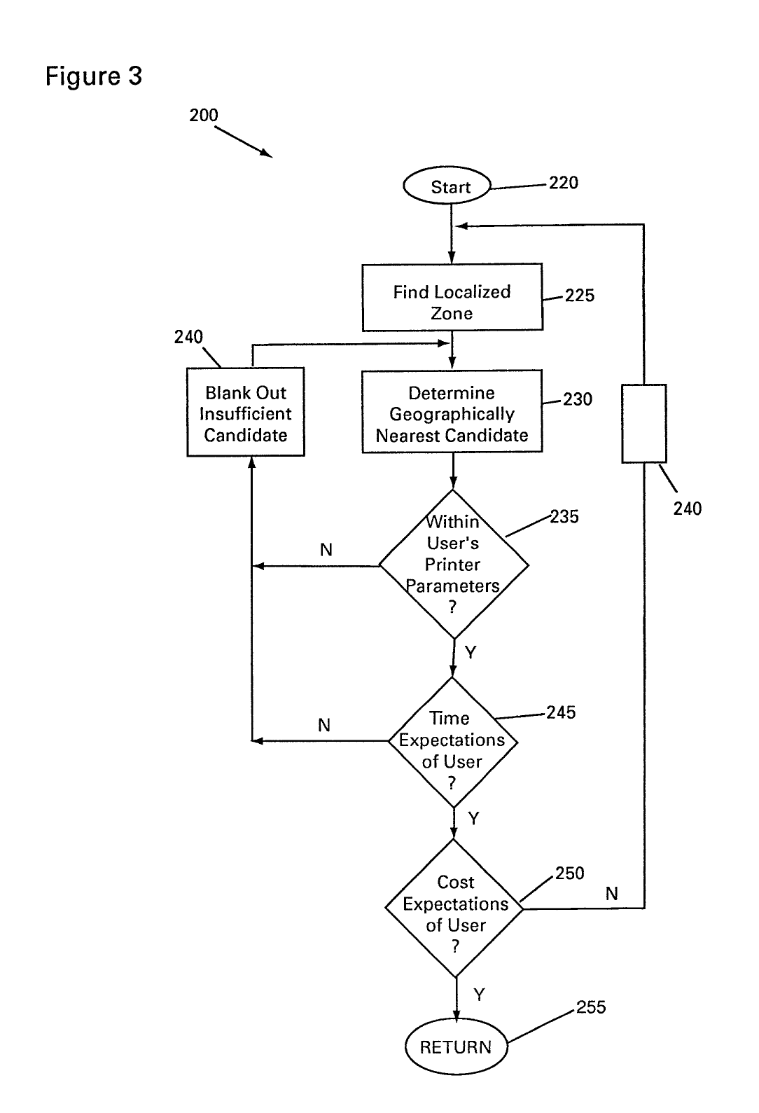

With specific reference to FIG. 3, the printer search routine 200 is initiated in step 220 by the assessor 25. In step 225, the assessor 25 establishes a localized zone of printer candiates. Because the geographical distances between printers within a communication network can span across a vast geographical area, the assessor 25 in step 225 searches for a group of printer candidates in the localized zone with respect to the network user locale 15. In this description and the appended claims the term “localized zone” is defined as a geographic region close to the network user locale 15. The number of printer candidates constituting the localized zone is based on a predetermined number set by the printer search routine 200 that meet or most nearly meet a user's parameters.

Based on the localized zone of printer candidates established in step 225, the assessor 25 in step 230 selects a printer candidate having the shortest distance to the network user locale 15. In addition to having the shortest distance, the printer candidate must satisfy any other of the network user's parameters to be selected as the localized printer 25 by the network addressable device 21.

Referring to FIG. 2, steps 135-250, the printer search routine 200 evaluates the printer candidate in accordance with the various network user parameters. In step 235, the assessor 25 determines whether a printer candidate satisfies the network user's printer parameters. In the description and the appended claims the term “printer parameters” refers to the print characteristics of a printer, such as print color, available paper sizing, and print resolution for example. If the printer candidate does not satisfy the required user printer parameters as shown in FIG. 3, the assessor 25 advances from step 235 to step 240 before looping back to step 230 to determine the next suitable printer candidate within the localized zone. In step 240, the rejected printer candidate is deleted from further consideration by the assessor 25 before the printer search routine 200 loops back to step 230 to select another candidate. On the other hand, if the printer candidate satisfies the user's printer parameters, the assessor 25 advances from step 235 to step 245.

In step 245, the assessor 25 determines whether the printer candidate satisfies the network user's time expectations. In the description and the appended claims the term “time expectations” refers to time that is required to print a print job by the printer candidate including, but not limited to, such factors as travel time between the network user locale 15 and the printer candidate, time it takes to engage or “spool” the printer, and waiting time required until the print job can be executed by the printer. If the printer candidate does not satisfy the time expectations, the assessor 25 advances from step 245 to step 240 before looping back to step 230 to determine the next suitable printer candidate within the localized zone. However, if the printer candidate satisfies the time expectations, the assessor 25 advances from step 245 to step 250.

In step 240, the assessor 25 determines whether the printer candidate satisfies the network user's cost expectations. In the description and the appended claims the term cost expectations refers to a range of expenses that a network user must pay for a print job on the printer candidate including, but not limited to, such factors as travel costs between the network user locale 15 and the printer candidate. If the printer candidate does not satisfy the cost expectations, the assessor 25 advances from step 250 to step 240 before looping back to step 225 to select a new localized zone of printer candidates. Alternatively, if the printer candidate satisfies the cost expectations, the assessor 25 advances from step 250 to step 255 to end the printer search routine 200.

On executing the printer search routine 200, the assessor 25 in step 125 of FIG. 2 displays a localized printer candidate to the network user before advancing to step 130. In step 130, the assessor 25 determines whether the provisionally selected localized printer candidate is available. To determine availability, the assessor 25 verifies, preferably in real-time, whether the localized printer candidate is operational. The assessor 25 also verifies whether a resulting print job falls within an expected print time range dictated by the network user parameters and is not delayed by a high volume of print command traffic.

If the localized printer candidate is available, the assessor 25 advances from step 130 to step 145. However, if the localized printer candidate is not available, the assessor 25 advances from step 130 to step 135.

In step 135, the network user is made aware that the provisionally selected localized printer candidate is not available and is queried whether a wait for the localized printer candidate is preferred. If the network user does not wish to wait for the provisionally selected localized printer, the print sequence 100 advances from step 135 to 140. In step 140, the provisionally selected localized printer candidate is deleted from further consideration by the assessor 25 before the print sequence 100 loops back to step 200 to select another candidate.

Alternatively, if the network user wishes to wait, the print sequence advances from step 130 to step 145. In step 145, the assessor 25 displays for the network user a status summary of the designated localized printer candidate. For example, the status summary may include information regarding the localized printer 35 such as the printer's geographical location, a real time countdown until a print job is completed, as well as the cost for printing. In addition, step 145 makes and receives a final spool request. Based on the final spool request, the assessor 25 in step 150 determines if the network user wishes to spool the printer candidate and thus designate the printer candidate as the localized printer 35. If the user does not want to use the printer candidate, the print sequence 100 advances from step 150 to step 140 before looping back to step 200 to thus begin the printer search routine again. If the network user is satisfied, the assessor 25 will advance from step 150 to step 155. In step 155 the assessor 25 will forward the print command to the localized printer 35 for spooling prior to ending the print sequence 100.

While the present invention has been disclosed in connection with the preferred embodiments thereof, it should be understood that there may be other embodiments which fall within the spirit and scope of the invention as defined by the following claims.

1. A network addressable device in a communications network for printing a document for a network user, comprising:
(a) a global printer array linked with the communications network; and
(b) an assessor linked with the global printer array and the network user, the assessor implementing a computer program code for selecting a localized printer from the global printer array.

2. The network addressable device according to claim 1 wherein the assessor receives network user parameters from the network user through the communications network.

3. The network addressable device according to claim 1 wherein the assessor establishes a localized zone of printer candidates, the localized printer selected from the localized zone.

4. The network addressable device according to claim 1 wherein the network addressable device further includes a repository for storing the information used for printing.

5. In a computer system, computer program code on computer readable media for printing a document for a network user, the computer program code comprising:
(a) a first computer program code for receiving network user parameters via a network addressable device;
(b) a second computer program code for linking the network addressable device with a global printer array;
(c) a third computer program code for selecting a localized printer from the global printer array;
(d) a fourth computer program code for determining the availability of the localized printer with respect to the network user parameters; and
(e) a fifth computer program code for spooling the localized printer.

6. The computer program code according to claim 5 wherein the third computer program code includes:
(a) a computer program code for establishing a localized zone of printer candidates; and
(b) a computer program code for designating the printer candidate at a minimum distance from the localized zone to the network user as the localized printer.

7. The computer program code according to claim 5 wherein the fourth computer program code includes a computer program code for determining whether the localized printer satisfies printer parameters of the network user.

8. The computer program code according to claim 5 wherein the fourth computer program code further includes a computer program code for determining cost expectations of the network user.

9. The computer program code according to claim 5 wherein the fourth computer program code further includes a computer program code for determining time expectations of the network user.

10. The computer program code according to claim 5 wherein the fifth computer program code includes a computer program code for displaying the status of the localized printer.

11. In a communications network environment, a method for printing a document for a network user, comprising the steps of:
(a) receiving network user parameters via a network addressable device;
(b) selecting a localized printer from a global printer array of the network addressable device with respect to the network user parameters;
(c) determining availability of the selected localized printer; and
(d) engaging the localized printer.

12. The method according to claim 11 wherein the step of receiving network user parameters includes the step of receiving network user parameters from an Internet communications network.

13. The method according to claim 12 wherein the step of receiving network user parameters includes the step of receiving network user parameters from a browser.

14. The method according to claim 11 wherein the step of receiving network user parameters includes the step of receiving network user parameters from an intranet communications network.

15. The method according to claim 11 wherein the step of selecting a localized printer includes the steps of:
(a) establishing a localized zone of printer candidates; and
(b) designating a printer candidate with a minimum distance from the localized zone to the network user as the localized printer.

16. The method according to claim 11 wherein the step of selecting a localized printer includes the step of determining whether the localized printer satisfies printer parameters of the network user.

17. The method according to claim 16 further comprising the step of displaying status of the localized printer.

18. The method according to claim 11 wherein the step of selecting a localized printer includes the step of determining time expectations associated with the localized printer.

19. The method according to claim 11 wherein the step of selecting a localized printer includes the step of determining costs associated with the localized printer.

20. The method according to claim 11 wherein step of selecting a localized printer includes the step of asking whether the network user wishes to wait if the localized printer is unavailable.
